(19) United States
(12) Patent Application Publication
(10) Pub. No.: US 2018/0368586 A1
(43) Pub. Date: Dec. 27, 2018

(54) WASHABLE SEAT COVER

(71) Applicants: Honda Motor Co., Ltd., Tokyo (JP); TB Kawashima Co., Ltd., Echi-gun (JP); SEIREN CO., LTD., Fukui-shi (JP); Sage Automotive Interiors Co., Ltd., Tokyo (JP)

(72) Inventors: Tomoyuki UEMURA, Wako-shi (JP); Tomoyo FUTAKAWAME, Wako-shi (JP); Kazuki KITAGAWA, Echi-gun (JP); Kentaro ISEKI, Echi-gun (JP); Hideki KONDO, Fukui-shi (JP); Takuro IZUMI, Fukui-shi (JP); Satoshi NISHIDA, Tokyo (JP)

(73) Assignees: Honda Motor Co., Ltd., Tokyo (JP); TB Kawashima Co., Ltd., Echi-gun (JP); SEIREN CO., LTD., Fukui-shi (JP); Sage Automotive Interiors Co., Ltd., Tokyo (JP)

(21) Appl. No.: 16/017,252

(22) Filed: Jun. 25, 2018

(30) Foreign Application Priority Data
Jun. 26, 2017 (JP) 2017-124687

(51) Int. Cl. A47C 31/11; B60N 2/60; B32B 5/02; B32B 7/14; D04B 21/20; B32B 5/26; B32B 5/06

(52) U.S. Cl. CPC A47C 31/11; B60N 2/60; B32B 5/026; B64D 11/0689; D04B 21/20; B32B 5/26; B32B 5/06; B32B 7/14

(57) ABSTRACT

A cover member is a detachable cover member of seat. The cover member comprises at least a skin material and a lining material which is positioned on a back side of the skin material, the lining material is a multistory cloth which is bonded on the back side of the skin material through bonding agent, the cover member comprises bonded parts which the bonding agent is adhered and non-bonded parts which the bonding agent is not adhered between the the multistory cloth and the skin material. And, the multistory cloth may be a multistory knitting fabric which is knitted by polyester resin-made threads, the bonded part may be arranged in any one out of a net-likeshape, a dot-like-shape and a checkered pattern, the bonded part may be arranged irregularly et cetera.

This application claims the benefit of Japanese Patent Application No. 2017-124687, filed Jun. 26, 2017, which is incorporated herein by reference in its entirety.

### FIELD OF THE INVENTION

A present invention relates to a seat cover member (as it were, washable seat cover) which is detachable and capable of resisting washing.

### BACKGROUND ART OF THE INVENTION

Hitherto, a cushion member which is available to seat (seat member) et cetera is known (refer to Japanese Unexamined Publication No.2006-207058).

The cushion member laminates one sheet of or plural sheets of multistory (multilayer) knit fabric, and/or one sheet of or plural sheets of multistory knit fabric and other material respectively, the cushion member has an outer periphery covered with an edge part cover material, and the outer periphery is sewed, a knitting fabric of at least one of front and back knitting fabrics of the multistory knit fabric is constituted by a mesh knitting fabric, a maximum diameter A of meshes of course directions of said mesh knitting fabric is 1 to 6 mm, a knitting fabric's width B of the course directions between meshes is 0.8 to 5 mm, a stitch's length C of sewing part of the outer periphery is 1.5 to 5.0 mm/stitch, a ratio (C/B) of the knitting fabric's width B and the stitch's length C is 0.5 to 5.0, a distance from an edge part of the multistory knit fabric to the sewing part is 5 to 20 mm

### Problem to be Solved

However, in the cushion member disclosed in Japanese Unexamined Publication No.2006-207058, there is a fear that a ventilation property of the whole seat cover can't secure, in a case that said cushion member is bonded on the skin material, and is utilized as a seat cover.

Moreover, it also is a problem that it takes time to dry after washing, when washing the seat cover which can't secure this ventilation property.

The present invention, in view of the problems like these, aims to provide a cover member which can realize “a securement of a ventilation property” and “a shortening of a drying time” et cetera at the same time, according to bonding a skin material and a multistory cloth, which is a lining material, through bonding agent, and comprising bonded parts which the bonding agent is adhering and non-bonded parts which the bonding agent is not adhering between the multistory cloth and the skin material et cetera.

### SUMMARY OF THE INVENTION

### Solution

The cover member 1 of the present invention is the 1st characterized by the following; the cover member is a seat detachable cover member; the cover member comprises at least a skin material and a lining material which is positioned on a back side of the skin material; the lining material is a multistory cloth which is bonded on the back side of the skin material through a bonding agent; the cover member comprises a bonded part which the bonding agent is adhering and a non-bonded part which the bonding agent is not adhering between the multistory cloth and the skin material.

The 2nd characteristic of the cover member 1 of the present invention is the following; in addition to the above 1st characteristic, the multistory cloth is a multistory knitting fabric which is knitted by polyester resin-made threads.

The 3rd characteristic of the cover member 1 of the present invention is the following; in addition to the above 1st characteristic, the bonded part is arranged in any one outof a net-like shape, a dot-like- shape and a checkered pattern.

The 4th characteristic of the cover member 1 of the present invention is the following; in addition to the above 1st characteristic, the bonded part is arranged irregularly.

The 5th characteristic of the cover member 1 of the present invention is, in addition to the above 1st characteristic, a zone occupied by the bonded parts is narrower than a zone occupied by the non-bonded part; the cover member comprises a plurality of the bonded parts, and the bonded parts are not continuous mutually; the cover member comprises one the non-bonded part, and the non-bonded part is continuous; the bonded parts are arranged to be surrounded by the non-bonded part.

The 6th characteristic of the cover member 1 of the present invention is the following; in addition to the above 1st characteristic, the multistory cloth is a double raschel knitting fabric which is connected between two sheets of warp knitting fabrics knitted by polyester resin-made warp threads with connection threads; the skin material is a warp knitting fabric knitted by polyester resin-made warp threads.

The 7th characteristic of the cover member 1 of the present invention is the following; in addition to the above 1st characteristic, an adhesion ratio, which is a rate of the bonded part occupying per unit area, is not less than 10% and not more than 90%.

The 8th characteristic of the cover member 1 of the present invention is a seat detachable cover member; the cover member comprises at least a skin material and a lining material which is positioned on a back side of the skin material; the lining material is a multistory cloth which is bonded on the back side of the skin material through a bonding agent; a peel strength between the skin material and the lining material, which are bonded by the bonding agent, is not less than 1.0 N/cm and not more than 10.0 N/cm in at least one direction of a vertical direction and a horizontal direction of said cover member, after performing a washing treatment represented by 103 method of JIS-L-0217:1995 or 140 method of JIS-L-0001:2014 against said cover member for 1 time.

Furthermore, “a washing treatment represented by 103 method of JIS-L-0217:1995 or 140 method of JIS-L-0001:2014” in the present invention does not only include a washing treatment as it is disclosed in 103 method of JIS-L-0217:1995 or 140 method of JIS-L-0001:2014, but also includes treatments conformed to washing treatments disclosed in said JISs respectively.

The 9th characteristic of the cover member 1 of the present invention is a seat detachable cover member; the cover member comprises at least a skin material and a lining material which is positioned on a back side of the skin material; the lining material is a multistory cloth which is bonded on the back side of the skin material through a bonding agent; a moisture content rate of said cover member is not more than 3%, when 2 hours pass after performing a washing treatment represented by 103 method of JIS-L-0217:1995 or 140 method of JIS-L-0001:2014 against said cover member for 1 time.

Owing to the characteristics, a ventilation property of the whole cover member 1 is secured in comparison to a case coating bonding agent in a film-like shape or on a whole surface, and it can shorten a drying time (a realization of “the securement of the ventilation property” and “the shortening of the drying time”), according to bonding the skin material 2 and the multistory cloth 3, which is a lining material, through the bonding agent 4, and providing the bonded parts 5 which the bonding agent 4 is adhering and non-bonded parts 5′ which the bonding agent 4 is not adhering between the multistory cloth 3 and the skin material 2.

And, a cushioning property as a seat member is secured, and it also can retain durable property against physical external pressure, according to which the multistory cloth 3 is a multistory knitting fabric 3′ knitted by polyester resin-made threads.

Then, it can make a discharge of moisture easily, cover member 1 is dried more quickly, it can make a removal of a detergent simply, according to locating a multistory knitting fabric 3′, which is a structure removing and changing the density (the density is removed mostly (a weight per unit volume becomes zero mostly), or the density is changed greatly in comparison to the skin material 2), as gradient material which achieves both a cushioning property and a discharge of moisture on a back 2b side of the skin material (a skin material having designedness) 2 contacting with a user (crew).

Moreover, there is nothing to be impeded the ventilation property, it can realize further “the shortening of the drying time” in comparison to the case coating bonding agent in a film-like shape or on a whole surface, according to arranging the bonded part 5 in any one out of a net-like shape, dot-like shapes and a checkered pattern.

Besides, there is nothing to be impeded the ventilation property, it can realize “the shortening of the drying time” in comparison to the case coating bonding agent in a film-like shape or on a whole surface, according to arranging the bonded part 5 irregularly, and making a zone occupied by the bonded parts 5 narrower than a zone occupied by the non-bonded part 5′, making the bonded part 5 plural and not continuous mutually, making the non-bonded part 5′ one and continuous and arranging the bonded part 5 to be surrounded by the non-bonded part 5′, too.

Furthermore, an adhesion ratio F, which is a rate of the bonded part 5 occupying per unit area, may be not less than 10% and not more than 90%.

Then, there is nothing to impede the ventilation property while securing a cushioning property as the cover member 1, it also can realize “the shortening of the drying time”, according to making the multistory cloth 3 a double raschel knitting fabric which is connected between two sheets of warp knitting fabrics 11, 12 knitted by polyester resin-made warp threads with connection threads 13, and making the skin material 2 a warp knitting fabric knitted by polyester resin-made warp threads.

And, it can enhance a washing resistance, according to making the peel strength H after performing a washing treatment for 1 time not less than 1.0 N/cm and not more than 10.0 N/cm in a vertical direction or a horizontal direction of the cover member 1, and it can realize “the shortening of the drying time”, according to making a moisture content rate B2K″ of the cover member 1 when 2 hours pass after performing a washing treatment for 1 time not more than 3%.

### Effect of the Invention

The cover member of the present invention can realize “the securement of the ventilation property” and “the shortening of the drying time”, according to bonding a skin material and a multistory cloth, which is a lining material, through bonding agent, and comprising bonded parts which the bonding agent is adhering and non-bonded parts which the bonding agent is not adhering between the multistory cloth and the skin material et cetera.

### BRIEF DESCRIPTION OF THE DRAWINGS

FIG. 1 shows a schematic view of using the cover member of the present invention.

FIG. 2 shows an oblique schematic view of the cover member.

FIG. 3 shows an oblique schematic view of a modified working example of the cover member.

FIG. 4 shows a photograph substituted for a figure of a working example 1 of the cover member, and FIG. 4(a) shows an oblique view show of the working example 1, FIG. 4(b) shows a side enlarged view (in particular, a view viewed from a wale direction) of the working example 1, FIG. 4(c) shows a state of venturing to peel a skin material and a lining material (a multistory cloth) in the working example 1.

FIG. 5 shows an enlarged photograph substituted for a figure of a bonding surface (a back side of the skin material) of the skin material which is peeled from the lining material (the multistory cloth) in the working example 1.

FIG. 6 shows an enlarged photograph substituted for a figure of a bonding surface (a front side of the lining material) of the lining material (the multistory cloth) which is peeled from the skin material in the working example 1.

### DETAILED DESCRIPTION OF THE INVENTION

<The Whole Constitution of the Cover Member 1>

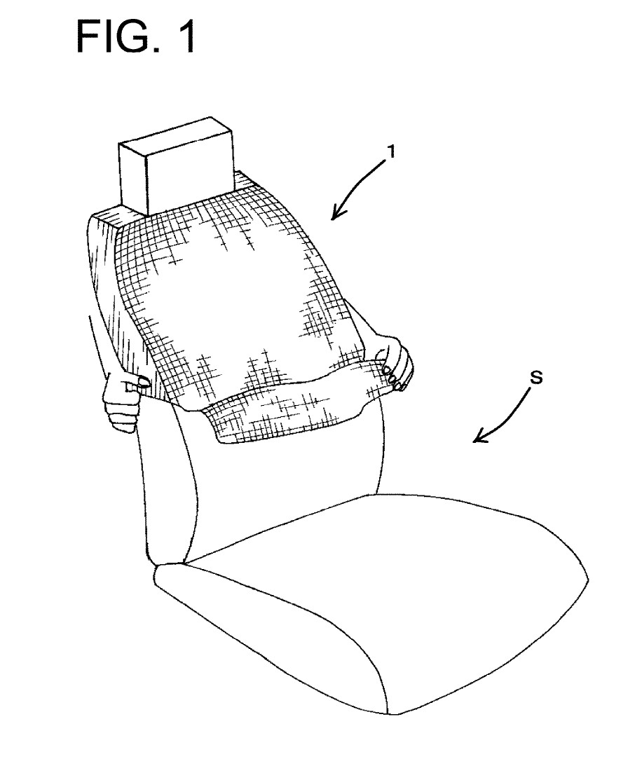

The embodiments of the present invention are explained to refer to the figures below. FIGS. 1 to 3 show the cover member 1 of the present invention, this cover member 1 covers a seat S, which is a car seat of the passenger car and so on, the cover member 1 is detachable (removable) against the seat S.

First, we describe the seat S covered the cover member 1.

<The Seat S>

As shown in FIG. 1, the seat S is seated by a user such as a crew, the seat S may be a seat (cockpit) or a chair et cetera, if the user can seat on, in addition to the above-mentioned car seat of the passenger car.

A shape, a color and a material and so on in the seat S are not particularly limited, and it does not matter whether or not the seat S has a headrest and/or an armrest.

We mainly describe the seat S is the car seat below.

Against such seat S, the cover member 1 may cover the whole of the seat S, the cover member 1 may cover only a backrest of the seat S, the cover member 1 may cover only a seated part, the cover member 1 may be divided into plural members to cover both the backrest and the seated part of the seat S and so on, the cover member 1 may be any constitution.

The cover member 1 comprises at least a skin material 2 and a lining material 3 which is positioned on a back 2b side of this skin material 2.

The cover member 1 may comprise a layer-like material, in addition to these skin material 2 and lining material 3, for example, another material, such as a sheet-like material and/or a mesh-like material (a net-like material), may exist between the skin material 2 and the lining material 3, a sheet-like material may be located on more back 3b side of the lining material 3.

Besides, the cover member 1 may comprise have a detachable member such as a hook-and-Loop fastener and/or a string, and/or a pocket and so on.

<The Skin Material 2>

As shown in FIGS. 1 to 3, the skin material 2 is positioned on an outermost side of the cover member 1, as mentioned above, the skin material 2 is a part (an exposed part) contacting with the user (crew).

And, it can be said that the skin material 2 (in particular, a front 2a side of the skin material 2) has a designedness too (that is, the skin material 2 is a skin material having designedness) because the skin material 2 is exposed and catch the user's eye, a surface property such as a color, a pattern and/or a ruggedness of the skin material 2 may be any constitution.

A material of the skin material 2 also is not particularly limited, for example, the material of the skin material 2 may be a synthetic leather (a synthetic skin), an artificial leather (an artificial skin), a natural leather and so on, cloth such as a woven fabric, a knit fabric (a warp knitting fabric such as a tricot knitting fabric knitted by warp threads, and/or a weft knitting fabric knitted by weft threads and so on), and a nonwoven fabric, a synthetic resin-made film and/or sheet et cetera.

The lining material 3 is positioned on the back 2b side of such skin material 2, it can also be said that the back 2b side of the skin material 2 is a bonding surface of the skin material 2 (the bonding surface against the lining material 3).

<The Lining Material (the Multistory Cloth) 3>

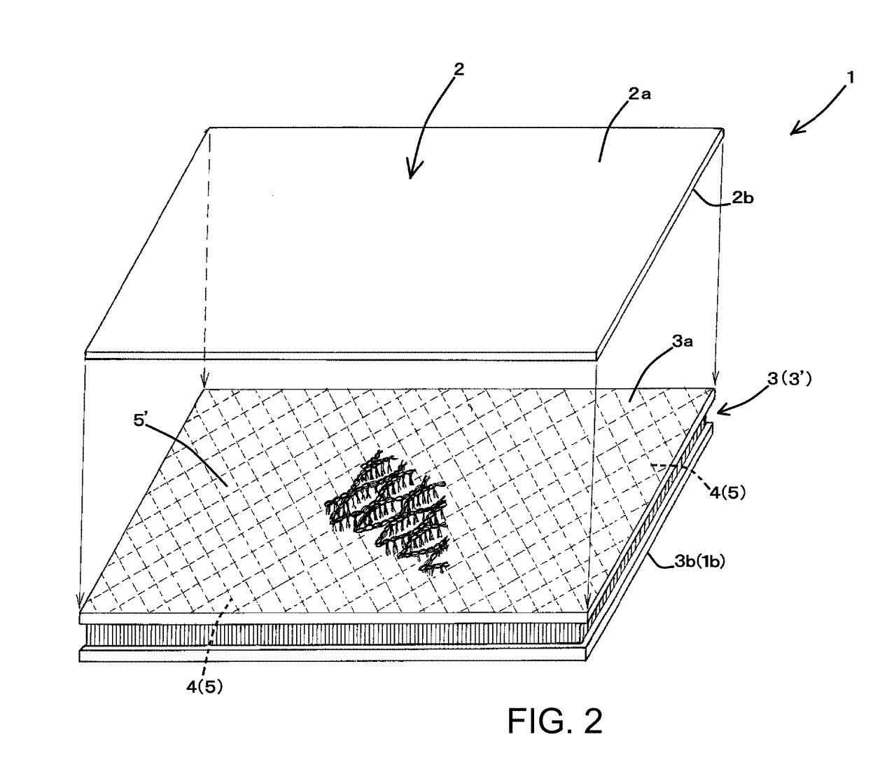

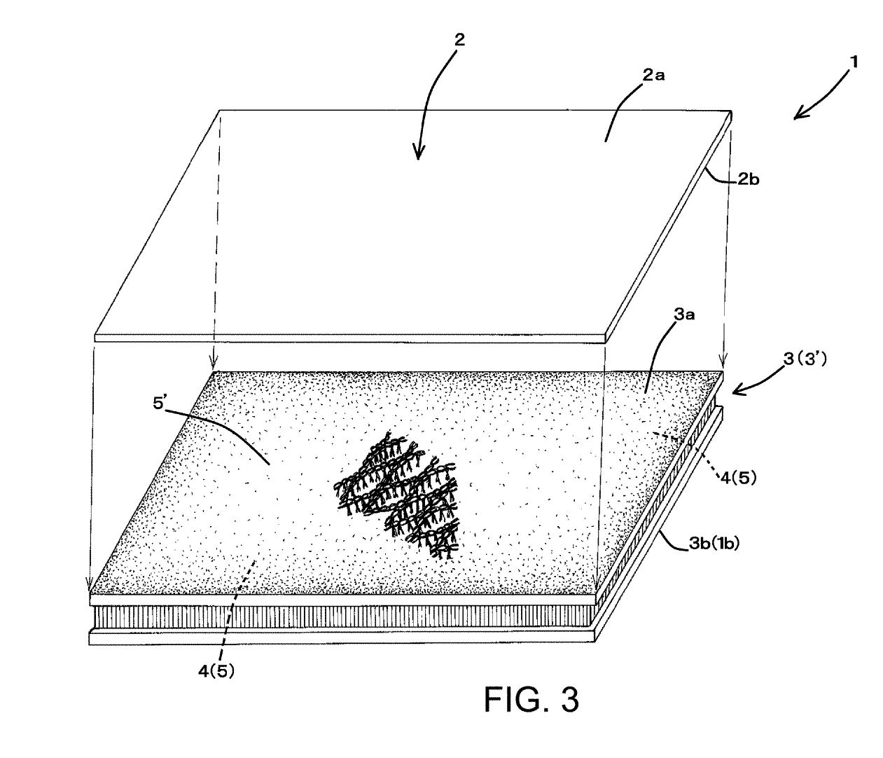

As shown in FIGS. 2, 3, the lining material 3 is positioned on the back 2b side of the skin material 2, and the lining material 3 is a multistory cloth 3 which is bonded on the back 2b side of the skin material 2.

At this point, “the lining material 3 is bonded on the back 2b side of the skin material 2 through the bonding agent 4” in the present invention means it includes a case that the lining material 3 is directly bonded on the back 2b of the skin material 2 through the bonding agent 4, and any case that the lining material 3 is positioned on the back 2b side of the skin material 2, such as a case that the lining material 3 is bonded through the bonding agent 4 interposing another material against the back 2b of the skin material 2 (as described in detail, the skin material 2 and the another material are bonded through the bonding agent 4, and the another material and the lining material 3 are bonded through the bonding agent 4), too.

Furthermore, it can also be said that the above-mentioned skin material 2 is positioned on a front 3a side of such lining material 3, and it can also be said that the front 3a side of the lining material 3 is a bonding surface of the lining material 3 (the bonding surface against the skin material 2).

And, “cloth” in the present invention also includes a nonwoven fabric, which is formed by methods such as a needle-punching method that fibers are hooked on going and returning needles and the fibers are mutually interlaced, or a thermal-bond method that thermally fusible fibers are contained and it make by heating, in addition to a knitting fabric (a knit fabric) knitted by warp threads or weft threads and a weaving fabric (a weave fabric) woven by warp threads and weft threads.

The multistory cloth 3 may be a multistory knitting fabric 3′ such as a double raschel knitting fabric et cetera, a pile woven fabric such as a moquette, and/or the nonwoven fabric and so on, if the multistory cloth 3 is a cloth which is stereophonical and has a cushioning property, the multistory cloth 3 may be any material.

Threads constituting the multistory cloth 3 may be a polyester resin-made, a nylon (polyamide, PA) resin-made, an acrylic (PMMA and so on) resin-made and/or a polyolefin resin-made such as a polyethylene (PE) resin-made and polypropylene (PP) resin-made et cetera.

We mainly describe the multistory cloth 3 is the multistory knitting fabric 3′ below.

<The Multistory Knitting Fabric 3′>

As shown in FIGS. 2, 3, the multistory knitting fabric 3′ may be the double raschel knitting fabric (a knitting fabric connecting two sheets of a warp knitting fabrics knitted by warp threads (a front warp knitting fabric and a back warp knitting fabric) with connection threads) and/or a pile knitting fabric raising a single jersey knitting fabric and so on, if a knitting fabric is stereophonical and has the cushioning property, the multistory knitting fabric 3′ may be any knitting structure and constitution.

Threads knitting this multistory knitting fabric 3′ is a polyester resin-made threads (a polyester threads), such as a polyethylene terephthalate (PET) resin-made threads, a polytrimethylene terephthalate (PTT) resin-made threads and/or a polybutylene terephthalate (PBT) resin-made threads and so on.

And, a fineness, a number of filaments, a number of twists and a sectional shape and so on in the threads of the multistory knitting fabric 3′ are not particularly limited.

<The Bonding Agent 4>

As shown in FIGS. 2, 3, the lining material 3 may be bonded through the bonding agent 4 against the back 2b side of the skin material 2.

A material of the bonding agent 4 is not limited, if the lining material 3 is bonded on the back 2b side of the skin material 2, a material of the bonding agent 4 may be any material, for example, the bonding agent 4 may be a synthetic resin-based bonding agent, such as an acrylic resin-based bonding agent, an olefin resin-based bonding agent, a vinyl acetate resin-based bonding agent, an epoxy resin-based bonding agent, a vinyl chloride resin-based bonding agent, a silicone resin-based bonding agent, a phenolic resin-based bonding agent, a polystyrene resin-based bonding agent, a polyvinyl alcohol resin-based bonding agent, an urethane resin-based bonding agent, a polyester resin-based bonding agent and/or a polyamide resin-based bonding agent, besides an animal glue, a colophonium and/or a natural bonding agent such as a starch-based bonding agent et cetera.

A state of the bonding agent 4 also is not particularly limited, a state of the bonding agent 4 may be an emulsion, a liquid state, a solid state (a hot-melt state), a tape-like shape and/or a nonwoven-fabric-like state and so on.

Furthermore, though the state of the bonding agent 4 is the nonwoven-fabric-like state et cetera before the lining material 3 is bonded on the back 2b of the skin material 2, the state of the bonding agent 4 may be not a nonwoven-fabric-like state et cetera after bonding, for example, after bonding, the state of the bonding agent 4 may be dot-like shapes described later, or a zone occupied by bonded parts 5 described later may be narrower than a zone occupied by a non-bonded part 5′ described later, the bonded parts 5 may be plural and not continuous mutually, the non-bonded part 5′ may be one and continuous, the bonded parts 5 may be arranged to be surrounded by the non-bonded part 5′.

If the bonding agent 4 exists between the back 2b side of the skin material 2 and the lining material 3 (the front 3a side of the lining material 3), and the skin material 2 and the lining material 3 are bonded, the bonding agent 4 may be adhered on at least a part of between the back 2b side of the skin material 2 and the front 3a side of the lining material 3 (that is, the cover member 1 comprises bonded parts 5 which the bonding agent 4 is adhering and the non-bonded part 5′ which the bonding agen t4 is not adhering), or the bonding agent 4 may be adhered on a whole surface of the back 2b side of the skin material 2 and the front 3a side of the lining material.

We mainly describe a case that the cover member 1 comprises bonded parts 5 and non-bonded part 5′ about the bonding agent 4 below.

<The Bonded Part 5, the Non-Bonded Part 5′>

As shown in FIGS. 2, 3, if the bonding agent 4 is adhered on at least a part of between the skin material 2 and the lining material 3, a shape (in particular, a plan-view shape) of the bonded part 5 and the non-bonded part 5′ is not particularly limited.

For example, the plan-view shape of the bonded part 5 may be a checkered pattern, in addition to a net-like shape (refer to FIG. 2) and/or dot-like shapes (refer to FIG. 3).

In a case that the bonded part 5 is in a net-like shape, shapes of the net mesh may be a quadrangle such as a square, a rhombus and a parallelogram, a hexagon, a triangle, a pentagon, an octagon and so on, the shapes of the net mesh may be any shapes, a size of the net mesh also is not particularly limited.

In a case that the bonded parts 5 are in dot-like shapes too, similarly, shapes of the dots may be a complete round-like shape and/or an elliptical and so on, diameters of the dots and distances between dots et cetera also are not particularly limited.

In a case that the bonded part 5 is in a checkered pattern (in a check pattern) too, similarly, each diagram constituting this checkered pattern may be a quadrangle such as a square, a rhombus and a parallelogram, each quadrangle of the checkered pattern may be curved, the bonded part 5 may form a combining checkered pattern which plural checkered patterns are combined, a size of each quadrangle also is not particularly limited.

Furthermore, the bonded parts 5 as discussed earlier may be in any one out of a net-like shape, dot-like shapes and a checkered pattern on the bonding surface of the skin material 2 and the lining material 3 in one sheet of the cover member 1, these shapes may be combined.

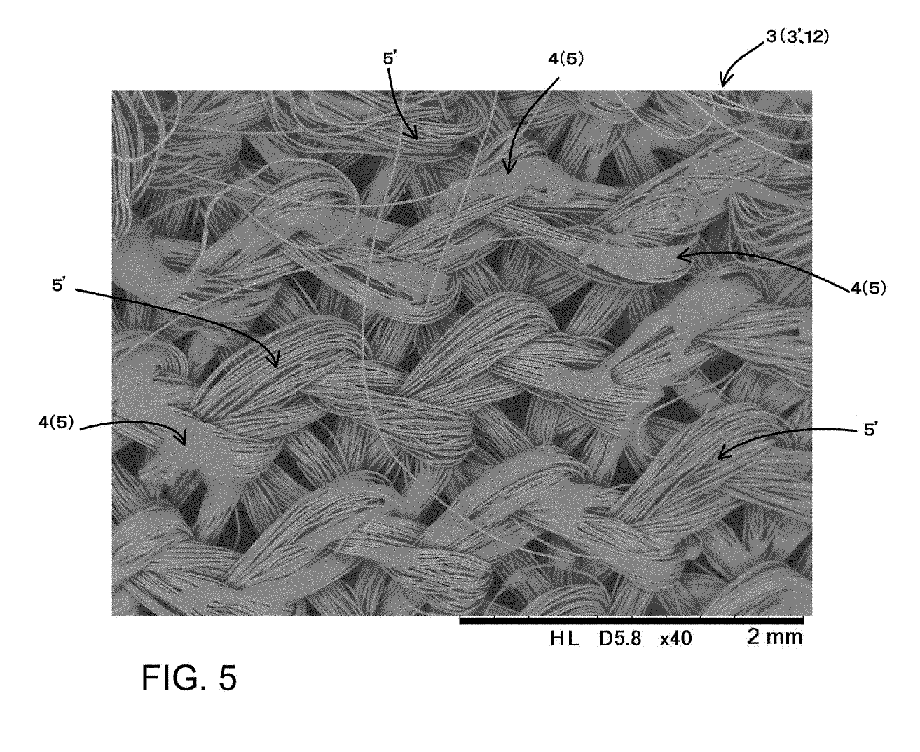

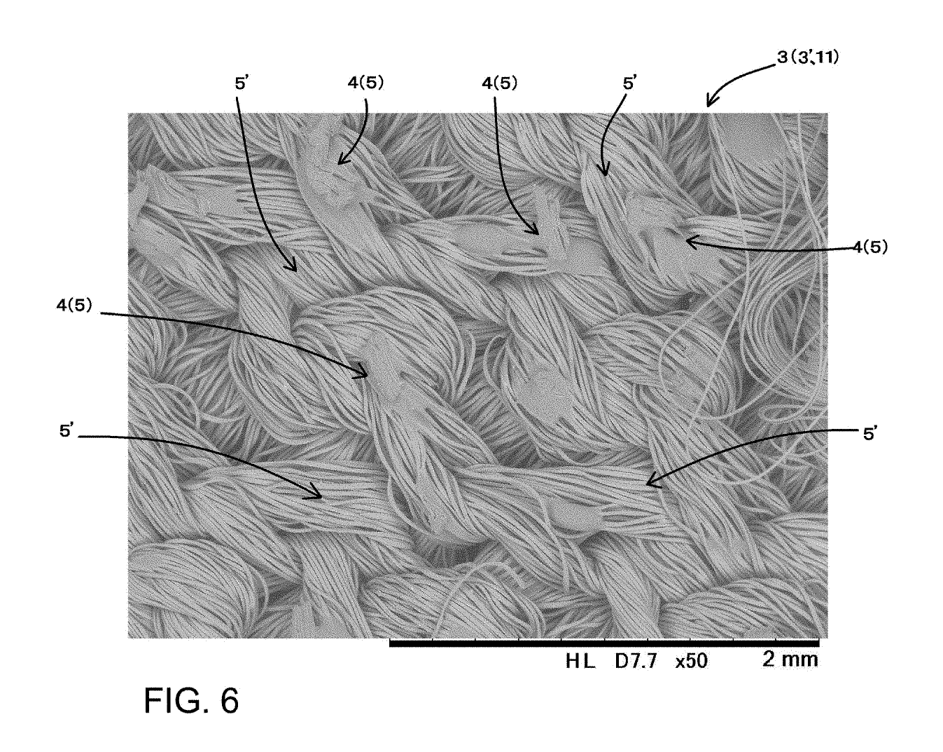

Besides, the bonded parts 5 may be arranged irregularly (having no regularity, and randomly) on the bonding surface of the skin material 2 and the lining material 3 (refer to FIGS. 5, 6 et cetera).

And, each shape of this bonded parts 5 arranged irregularly is not particularly limited, each shape of this bonded parts 5 may be an approximately pentagon, an approximately hexagon and/or an approximately octagon and so on, in addition to an approximately complete round-like shape, an approximately elliptical, an approximately triangle, an approximately quadrangle such as an approximately square, an approximately rhombus and an approximately parallelogram, these shapes may be combined on the bonding surface of the skin material 2 and the lining material 3 in one sheet of the cover member 1.

And, the zone occupied by the bonded parts 5 may be narrower than the zone occupied by the non-bonded part 5′ on the bonding surface of the skin material 2 and the lining material 3, the bonded parts 5 may be plural and not continuous mutually, the non-bonded part 5′ may be one and continuous, the bonded parts 5 may be arranged to be surrounded by the non-bonded part 5′ (refer to FIGS. 5, 6 et cetera).

Characteristics such as the shapes of the dot-like shapes et cetera in the bonded part 5 as discussed earlier, and/or an arrangement shown in FIGS. 5, 6 et cetera in the bonded parts 5 and the non-bonded part 5′ may be characteristics on the bonding surface before the skin material 2 and the lining material 3 in fact are bonded, the characteristics such as the shapes of the dot-like shapes et cetera, and/or an arrangement shown in FIGS. 5, 6 et cetera may be characteristics on the bonding surface in a state of venturing to be peeled the skin material 2 and the lining material 3 which are bonded once.

<The Adhesion Ratio F of the Bonding Agent 4 and So On>

If the above-mentioned bonding agent 4 is adhered on at least a part of between the skin material 2 and the lining material 3, a rate of the bonded part 5 which the bonding agent 4 is adhering occupying per unit area (an adhesion ratio of the bonding agent 4) F also is not particularly limited, for example, the adhesion ratio F may be not less than 10% and not more than 90%, preferably be not less than 20% and not more than 80%, more preferably be not less than 30% and not more than 70%.

If this adhesion ratio F is less than 10%, it can also be said that a rate of point contacts between the bonding agent 4 and the multistory cloth 3 (in particular, the multistory knitting fabric 3′ of the double raschel knitting fabric) becomes larger, it become difficult to make the lining material 3 firmly bonded on the back 2b side of the skin material 2, if the adhesion ratio F is more than 90%, it can also be said that a discharging property of moisture gets worse.

And, the adhesion ratio F may be uneven between the skin material 2 and the lining material 3, there may be partially a place where adhesion ratio F is high and/or a place where adhesion ratio F is low.

Besides, a weight M per unit area (a coating amount per unit area) of the bonding agent 4 also is not particularly limited, for example, the weight per unit area may be not less than 20 g/m² and not more than 50 g/m², preferably be not less than 25 g/m² and not more than 45 g/m², more preferably be not less than 30 g/m² and not more than 40 g/m².

<The Peel Strength H>

It can also be said that the peel strength H between the skin material 2 and the lining material 3 bonded by such bonding agent 4 differs depending on the adhesion ratio F, the weight M per unit area, a material and/or a state of the bonding agent 4, before washing or after washing (after performing washing treatments for predetermined times), and/or a surface property in the bonding surface of the skin material 2 and the lining material 3 and so on.

A concrete value of the peel strength H is not particularly limited, for example, first, the peel strength H before washing (in normal state) may be not less than 1.0 N/cm and not more than 6.0 N/cm, preferably be not less than 1.5N/cm and not more than 5.5N/cm, more preferably be not less than 2.0N/cm and not more than 5.0N/cm in a vertical direction (if the skin material 2 and the lining material 3 are the knitting fabric and/or the weaving fabric, a warp direction), the peel strength H before washing may be not less than 1.0N/cm and not more than 13.0N/cm, preferably be not less than 1.5N/cm and not more than 12.0N/cm, more preferably be not less than 2.0N/cm and not more than 10.0N/cm in a horizontal direction (if the skin material 2 and the lining material 3 are the knitting fabric and/or the weaving fabric, a welt direction).

And, a concrete value of the peel strength H after washing (for example, after performing a washing treatment (a washing treatment represented by 103 method of JIS-L-0217:1995 or 140 method of JIS-L-0001:2014 et cetera) for 1 time and so on) may be not less than 1.0N/cm and not more than 6.0N/cm, preferably be not less than 2.0N/cm and not more than 5.0N/cm, more preferably be not less than 3.0N/cm and not more than 4.0N/cm in the vertical direction, the concrete value of the peel strength H after washing may be not less than 1.0 N/cm and not more than 10.0 N/cm, preferably be not less than 1.5N/cm and not more than 9.0N/cm, more preferably be not less than 2.0N/cm and not more than 8.0N/cm in the horizontal direction.

Furthermore, the peel strength H may be measured by a predetermined standard, the peel strength H may be measured by a test method shown in JIS-K-6848-1:1999, JIS-K-6854-1:1999, JIS-K-6854-2:1999, JIS-K-6854-3:1999 and/or JIS-K-6854-4:1999 et cetera.

And, “the test method shown in the JIS-K-6848-1:1999 et cetera” in the present invention, as mentioned above, does not only includes a test method as it is disclosed in the JIS-K-6848-1:1999 et cetera, but also includes methods conformed to test methods disclosed in said JISs respectively.

<The Ventilation Degree T>

It can also be said that a ventilation degree T as the whole cover member 1 differs depending on the adhesion ratio F, the weight M per unit area, the material and/or the state of the bonding agent 4, and/or before washing or after washing et cetera, in addition to a material, a structure and/or a weight per unit area of the skin material 2 and the lining material 3 constituting the cover member 1.

A concrete value of the ventilation degree T also is not particularly limited, for example, the concrete value of the ventilation degree T may be not less than 10 ml(milliliters)/cm²/sec and not more than 40 ml/cm²/sec, preferably be not less than 15 ml/cm²/sec and not more than 35 ml/cm²/sec, more preferably be not less than 18 ml/cm²/sec and not more than 30 ml/cm²/sec.

Furthermore, the ventilation degree T also may be measured by a predetermined standard, the ventilation degree T may be measured by a test method shown in A method (Fragile form method), B method (Gurley form method) or C method (ISO method) of JIS-L-1096:2010 et cetera.

And, “the test method shown in the A method of the JIS-L-1096:2010 et cetera” in the present invention, as mentioned above, does not only includes a test method as it is disclosed in the A method of the JIS-L-1096:2010 et cetera, but also includes methods conformed to test methods disclosed in said JISs respectively.

<The Drying Property K>

It can also be said that a drying property K as the whole cover member 1 also differs depending on the adhesion ratio F, the weight M per unit area, the material and/or the state of the bonding agent 4, and/or before washing or after washing et cetera, in addition to a material, a structure and/or a weight per unit area of the skin material 2 and the lining material 3 constituting the cover member 1.

About the drying property K of the cover member 1, for example, we measure a weight (A) of the cover member 1 before washing, we measure a weight (B0) immediately after washing (for example, immediately after performing a washing treatment (a washing treatment represented by 103 method of JIS-L-0217:1995 or 140 method of JIS-L-0001:2014 et cetera) for 1 time and so on), thereafter, we measure weights per 1 hour until drying (if 1 hour passes after washing, we measure a weight (B1), if 2 hours pass after washing, we measure a weight (B2), if n hours pass after washing, we measure a weight (Bn)). If we subtract Bn from A (=Bn−A), it is revealed a moisture content amount BnK′ in the cover member 1 when n hours pass after washing, if we divide what A subtracted from Bn by A (=(Bn−A)/A), it is revealed a moisture content rate BnK″ (an unit is %) in the cover member 1 when n hours pass after washing. And, it can also be said that we can determine the drying property K from a change (a decreasing degree) of these moisture content amount BnK′ and moisture content rate BnK″.

Furthermore, a concrete value of the moisture content amount BnK′ when n hours pass changes depending on a weight of a sample itself which is measured too.

And so, as for a concrete value of the moisture content rate BnK″ when n hours pass after washing, the concrete value of the moisture content rate BnK″ also is not particularly limited, for example, the moisture content rate B0K″ when 0 hour passes (immediately after washing) may be not less than 10% and not more than 80%, preferably be not less than 15% and not more than 70%, more preferably be not less than 20% and not more than 65%, the moisture content rate B1K″ when 1 hour passes after washing may be not less than 0% and not more than 40%, preferably be not less than 3% and not more than 35%, more preferably be not less than 5% and not more than 30%, the moisture content rate B2K″ when 2 hours pass after washing may be not less than 0% and not more than 20%, preferably be not less than 0% and not more than 15%, more preferably be not less than 0% and not more than 13%.

In particular, it can also be said that the moisture content rates B3K″, B4K″, B5K″ et cetera in the cover member 1 when 3 hours pass or later are 0%.

<The Tests 1 to 4>

From here, first, we mention working examples 1 to 5 of the cover member 1 of the present invention and a comparative example 1.

In these examples, we perform a test 1 described later by using the working examples 1 to 3, we perform tests 2, 3 described later by using the working examples 1, 2 and the comparative example 1, we perform a test 4 described later by using the working example 5.

Furthermore, the cover members 1 of the present invention are obviously not limited to the skin material 2 and/or the lining material 3 (the multistory knitting fabric 3′) mentioned in the following working examples 1 to 5.

And, a washing treatment applied to the above-mentioned working examples 1 to 5, for example, may be any washing treatments such as washing manners disclosed in JIS-L-0217:1995 and/or JIS-L-0001:2014 and so on, in addition to 103 method disclosed in JIS-L-0217:1995 and/or 140, 141, 142 methods disclosed in JIS-L-0001:2014.

### THE WORKING EXAMPLE 1

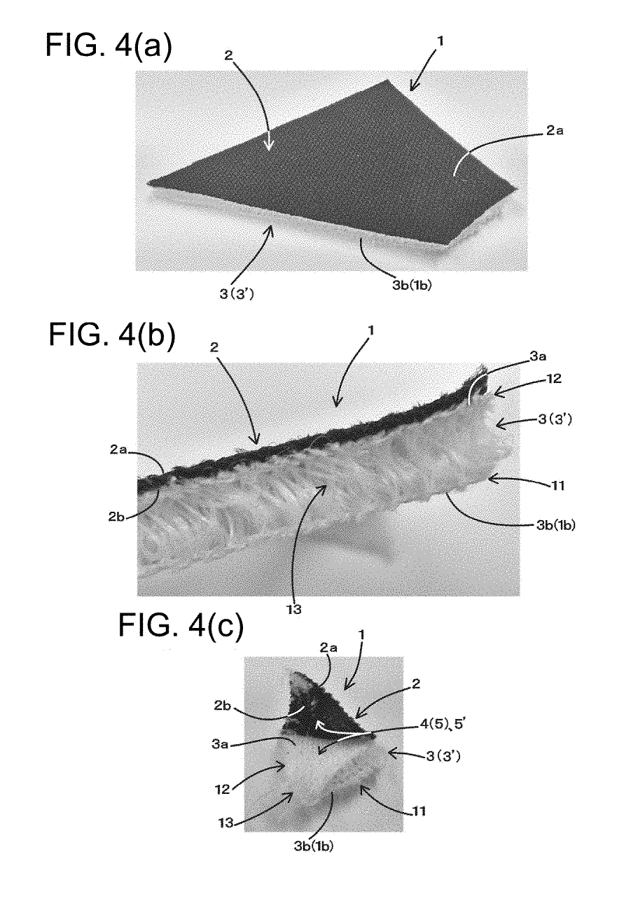

The skin material 2 of the working example 1 shown in FIGS. 4 to 6 is a tricot knitting fabric knitted by using 3 sheets of reeds of the 1st reed (a back reed), the 2nd reed (a middle reed) and the 3rd reed (a front reed).

The tricot knitting fabric, which is the skin material 2 of the working example 1, is knitting by polyester multifilament threads (167 dtex, 48 filaments, processed threads) interknitted to repeatedly operate the 1st reed in order of 1-0/4-5/1-0/3-4, polyester multifilament threads (75 dtex, 24 filaments, raw threads) interknitted to repeatedly operate the 2nd reed in order of 1-2/2-3/1-0/1-2, and polyester multifilament threads (75 dtex, 24 filaments, raw threads) interknitted to repeatedly operate the 3rd reed in order of 1-0/1-2/1-2/2-3.

In the tricot knitting fabric as the skin material 2, a wale density of the tricot knitting fabric is 28 threads(wales)/inch and a course density of the tricot knitting fabric is 59 course/inch on a knitting machine, a wale density of the tricot knitting fabric is 35 threads(wales)/inch and a course density of the tricot knitting fabric is 50 course/inch on after heating.

The lining material 3 (the multistory knitting fabric 3′) of the working example 1 shown in FIGS. 4 to 6 is a double raschel knitting fabric knitted to connect between two sheets of warp knitting fabrics (a front warp knitting fabric 11, a back warp knitting fabric 12) with connection threads 13 by using 5 sheets of reeds (the 1st to 5th reeds). Furthermore, the front warp knitting fabric 11 is a warp knitting fabric of the front 3a side of the lining material 3, the front warp knitting fabric 11 becomes the bonding surface of the lining material 3, the back warp knitting fabric 12 is a warp knitting fabric of the back 3b side of the lining material 3, the back warp knitting fabric 12 is positioned on a most back 1b side of the whole cover member 1.

The double raschel knitting fabric, which is the lining material 3 (the multistory knitting fabric 3′) of the working example 1, is knitting by polyester multifilament threads (84 dtex, 36 filaments, processed threads) interknitted to repeatedly operate the 1st reed in order of 0-1_1-1/2-1_1-1/2-3_3-3/2-1_1-1, polyester multifilament threads (84 dtex, 36 filaments, processed threads) interknitted to repeatedly operate the 2nd reed in order of 2-3_3-3/2-1_1-1/0-1_1-1/2-1_1-1, polyester multifilament threads (75 dtex, 36 filaments, raw threads) interknitted to repeatedly operate the 3rd reed in order of 2-3_1-2/1-0_2-1, polyester multifilament threads (75 dtex, 36 filaments, raw threads) interknitted to repeatedly operate the 4th reed in order of 1-2_2-3/2-1_1-0, polyester multifilament threads (84 dtex, 36 filaments, processed threads) interknitted to repeatedly operate the 5th reed in order of 0-0_2-3/3-3_1-0.

In the double raschel knitting fabric as the lining material 3, a wale density of the double raschel knitting fabric is 22 threads(wales)/inch and a course density of the double raschel knitting fabric is 45 course/inch on a knitting machine, a wale density of the double raschel knitting fabric is 24 threads(wales)/inch and a course density of the double raschel knitting fabric is 43 course/inch on after heating.

Furthermore, in the working example 1, the back warp knitting fabric 12 of the lining material 3 is knitted by the 1st reed and the 2nd reed, the back warp knitting fabric 12 and the front warp knitting fabric 11 of the lining material 3 is connected with connection threads 13 by the 3rd reed and the 4th reed, the front warp knitting fabric 11 of the lining material 3 is knitted by the 5th reed.

As described this in detail, as mentioned above, the back warp knitting fabric 12 of the lining material 3 becomes to be knitted by the 1st reed and the 2nd reed, according to needle loops being formed on the back warp knitting fabric 12 to operate the 1st reed and the 2nd reed like first half of each course (When showing the 1st reed as an example, “0-1” and “2-1” of the first half in the each course such as “0-1_1-1” or “2-1_1-1” delimited by “/” in the above order and so on), and according to no needle loop being formed on the front warp knitting fabric 11 to operate the 1st reed and the 2nd reed like last half of the each course (When showing the same 1st reed as an example, each“1-1” of the last half in the each course such as “0-1_1-1” or “2-1_1-1” delimited by “/” in the above order and so on).

And, as mentioned above, the back warp knitting fabric 12 and the front warp knitting fabric 11 of the lining material 3 become to be connected with connection threads 13 by the 3rd reed and the 4th reed, according to needle loops being formed on the back warp knitting fabric 12 to operate the 3rd reed and the 4th reed like the first half of the each course, and according to needle loops also being formed on the front warp knitting fabric 11 to operate the 3rd reed and the 4th reed like the last half of the each course). Furthermore, in the working example 1, needle loops become to be formed to opposite direction position (alternately) for each one course by the connection threads 13, according to operating the 3rd reed and the 4th reed as mentioned above, in a side view of the cover member 1 (the multistory knitting fabric 3′), each of plural connection threads 13 mutually intersects (refer to FIG. 4(b)).

Moreover, as mentioned above, the front warp knitting fabric 11 of the lining material 3 becomes to be knitted by the 5th reed, according to no needle loop being formed on the back warp knitting fabric 12 to operate the 5th reed like the first half of each course, and according to needle loops being formed on the front warp knitting fabric 11 to operate the 5th reed like the last half of the each course, in contrary to the 1st reed and the 2nd reed.

As shown in FIGS. 5, 6, the bonded parts 5 are arranged irregularly (having no regularity, and randomly) on the bonding surface of the skin material 2 and the lining material 3 in the working example 1, and the zone occupied by the bonded parts 5 is narrower than the zone occupied by the non-bonded part 5′, the bonded parts 5 are plural and not continuous mutually, the non-bonded part 5′ is one and continuous, the bonded parts 5 are arranged to be surrounded by the non-bonded part 5′.

And, in the working example 1, a polyamide resin-based nonwoven-fabric-like hot-melt agent is used as the bonding agent 4, which becomes the bonded part 5, and the weight M per unit area (a coating amount per unit area) of the bonding agent 4 is 30 g/m².

### THE WORKING EXAMPLE 2

In the cover member 1 of the working example 1, the cover member 1 of the working example 2 is obtained, according to making the weight M per unit area of the bonding agent 4 40 g/m².

### THE WORKING EXAMPLE 3

In the cover member 1 of the working example 1, the cover member 1 of the working example 3 is obtained, according to using a polyester resin-based nonwoven-fabric-like hot-melt agent as the bonding agent 4, which becomes the bonded part 5, and making the weight M per unit area of the bonding agent 4 30 g/m².

### THE WORKING EXAMPLE 4

The skin material 2 of the working example 4, as mentioned above, is not particularly limited, for example, like the working example 1, the skin material 2 of the working example 4 may be a tricot knitting fabric knitted by using 3 sheets of reeds of the 1st reed (a back reed), the 2nd reed (a middle reed) and the 3rd reed (a front reed), and the skin material 2 of the working example 4 may be a knit fabric such as a warp knitting fabric or a weft knitting fabric, or a woven fabric and so on.

The lining material 3 (the multistory knitting fabric 3′) of the working example 4 is a double raschel knitting fabric knitted to connect between two sheets of warp knitting fabrics (a front warp knitting fabric 11, a back warp knitting fabric 12) with connection threads 13 by using 5 sheets of reeds, in more detail, the 1st to 3rd reeds and the 5th, 6th reeds. Furthermore, as with the working examples 1 to 3, the front warp knitting fabric 11 is a warp knitting fabric of the front 3a side of the lining material 3, the front warp knitting fabric 11 becomes the bonding surface of the lining material 3, the back warp knitting fabric 12 is a warp knitting fabric of the back 3b side of the lining material 3, the back warp knitting fabric 12 is positioned on a most back 1b side of the whole cover member 1.

The double raschel knitting fabric, which is the lining material 3 (the multistory knitting fabric 3′) of the working example 4, is knitting by polyester multifilament threads (84 dtex, 36 filaments, single threads, semi-dull raw threads) interknitted to repeatedly operate the 1st reed in order of (2-1_1-1/2-3_3-3)*2/2-1_1-1/(1-2_2-2/1-0_0-0)*2/1-2_2-2, polyester multifilament threads (84 dtex, 36 filaments, single threads, semi-dull raw threads) interknitted to repeatedly operate the 2nd reed in order of (1-2_2-2/1-0_0-0)*2/1-2_2-2/(2-1_1-1/2-3_3-3)*2/2-1_1-1, polyester monofilament threads (33 dtex, single threads, semi-dull raw threads) interknitted to repeatedly operate the 3rd reed in order of 1-0_1-0/1-2_1-2, polyester multifilament threads (110 dtex, 48 filaments, single threads, semi-dull raw threads) interknitted to repeatedly operate the 5th reed in order of 2-2_1-0/0-0_1-2, polyester multifilament threads (110 dtex, 48 filaments, single threads, semi-dull raw threads) interknitted to repeatedly operate the 6th reed in order of 0-0_1-2/2-2_1-0.

In the double raschel knitting fabric as the lining material 3, a wale density of the double raschel knitting fabric is 22 threads(wales)/inch and a course density of the double raschel knitting fabric is 43 course/inch on a knitting machine, a wale density of the double raschel knitting fabric is 22 threads(wales)/inch and a course density of the double raschel knitting fabric is 46 course/inch on after heating.

Furthermore, in the working example 4, the back warp knitting fabric 12 of the lining material 3 is knitted by the 1st reed and the 2nd reed, the back warp knitting fabric 12 and the front warp knitting fabric 11 of the lining material 3 is connected with connection threads 13 by the 3rd reed, the front warp knitting fabric 11 of the lining material 3 is knitted by the 5th reed and 6th reed.

As described this in detail, as mentioned above, the back warp knitting fabric 12 of the lining material 3 becomes to be knitted by the 1st reed and the 2nd reed, according to needle loops being formed on the back warp knitting fabric 12 to operate the 1st reed and the 2nd reed like the first half of each course, and according to no needle loop being formed on the front warp knitting fabric 11 to operate the 1st reed and the 2nd reed like the last half of the each course.

And, as mentioned above, the back warp knitting fabric 12 and the front warp knitting fabric 11 of the lining material 3 become to be connected with connection threads 13 by the 3rd reed, according to needle loops being formed on the back warp knitting fabric 12 to operate the 3rd reed like the first half of the each course, and according to needle loops also being formed on the front warp knitting fabric 11 to operate the 3rd reed like the last half of the each course). Furthermore, in the working example 4, needle loops become to be formed to opposite direction position (alternately) for each two courses by the connection threads 13, according to operating the 3rd reed as mentioned above, in a side view of the cover member 1 (the multistory knitting fabric 3′), each of plural connection threads 13 mutually intersects.

Moreover, as mentioned above, the front warp knitting fabric 11 of the lining material 3 becomes to be knitted by the 5th reed and the 6th reed, according to no needle loop being formed on the back warp knitting fabric 12 to operate the 5th reed and the 6th reed like the first half of each course, and according to needle loops being formed on the front warp knitting fabric 11 to operate the 5th reed and the 6th reed like the last half of the each course, in contrary to the 1st reed and the 2nd reed.

Also in the working example 4, the bonded parts 5 are arranged irregularly (having no regularity, and randomly) on the bonding surface of the skin material 2 and the lining material 3, and the zone occupied by the bonded parts 5 is narrower than the zone occupied by the non-bonded part 5′, the bonded parts 5 are plural and not continuous mutually, the non-bonded part 5′ is one and continuous, the bonded parts 5 are arranged to be surrounded by the non-bonded part 5′.

And, in the working example 4, an urethane resin-based hot-melt agent is used as the bonding agent 4, which becomes the bonded part 5, and the weight M per unit area of the bonding agent 4 is 35 g/m².

### THE WORKING EXAMPLE 5

The skin material 2 of the working example 5, as mentioned above, also is not particularly limited, for example, like the working example 1, the skin material 2 of the working example 5 may be a tricot knitting fabric knitted by using 3 sheets of reeds of the 1st reed (a back reed), the 2nd reed (a middle reed) and the 3rd reed (a front reed), and the skin material 2 of the working example 5 may be a knit fabric such as a warp knitting fabric or a weft knitting fabric, or a woven fabric and so on.

The lining material 3 (the multistory knitting fabric 3′) of the working example 5 is a double raschel knitting fabric knitted to connect between two sheets of warp knitting fabrics (a front warp knitting fabric 11, a back warp knitting fabric 12) with connection threads 13 by using 6 sheets of reeds (the 1st to 6th reeds). Furthermore, as with the working examples 1 to 4, the front warp knitting fabric 11 is a warp knitting fabric of the front 3a side of the lining material 3, the front warp knitting fabric 11 becomes the bonding surface of the lining material 3, the back warp knitting fabric 12 is a warp knitting fabric of the back 3b side of the lining material 3, the back warp knitting fabric 12 is positioned on a most back 1b side of the whole cover member 1.

The double raschel knitting fabric, which is the lining material 3 (the multistory knitting fabric 3′) of the working example 5, is knitting by polyester multifilament threads (75 dtex, 36 filaments, single threads, semi-dull raw threads) interknitted to repeatedly operate the 1st reed in a predetermined order, polyester multifilament threads (75 dtex, 36 filaments, single threads, semi-dull raw threads) interknitted to repeatedly operate the 2nd reed in a predetermined order, polyester monofilament threads (30 dtex, separated threads) interknitted to repeatedly operate the 3rd reed in a predetermined order, polyester monofilament threads (30 dtex, separated threads) interknitted to repeatedly operate the 4th reed in a predetermined order, polyester multifilament threads (75 dtex, 36 filaments, single threads, semi-dull raw threads) interknitted to repeatedly operate the 5th reed in a predetermined order, polyester multifilament threads (75 dtex, 36 filaments, single threads, semi-dull raw threads) interknitted to repeatedly operate the 6th reed in a predetermined order.

In the double raschel knitting fabric as the lining material 3, a wale density of the double raschel knitting fabric is 22 threads(wales)/inch and a course density of the double raschel knitting fabric is 30 course/inch on a knitting machine, a wale density of the double raschel knitting fabric is 25 threads(wales)/inch and a course density of the double raschel knitting fabric is 32 course/inch on after heating.

Furthermore, in the working example 5, the back warp knitting fabric 12 of the lining material 3 is knitted by the 1st reed and the 2nd reed, the back warp knitting fabric 12 and the front warp knitting fabric 11 of the lining material 3 is connected with connection threads 13 by the 3rd reed and the 4^{th} reed, the front warp knitting fabric 11 of the lining material 3 is knitted by the 5th reed and 6th reed.

Also in the working example 5, the bonded parts 5 are arranged irregularly (having no regularity, and randomly) on the bonding surface of the skin material 2 and the lining material 3, and the zone occupied by the bonded parts 5 is narrower than the zone occupied by the non-bonded part 5′, the bonded parts 5 are plural and not continuous mutually, the non-bonded part 5′ is one and continuous, the bonded parts 5 are arranged to be surrounded by the non-bonded part 5′.

And, in the working example 5, an urethane resin-based hot-melt agent is used as the bonding agent 4, which becomes the bonded part 5, and the weight M per unit area of the bonding agent 4 is 32 g/m².

### THE COMPARATIVE EXAMPLE 1

In the cover member 1 of the working example 1, the cover member of the comparative example 1 is obtained, according to using an approximately plate-like urethane foaming material (a weight per unit area is 20 kg/m², and a thickness is 3 mm) as the lining material 3, and also according to using a polyester resin-based nonwoven-fabric-like hot-melt agent as the bonding agent 4, which becomes the bonded part 5, and making the weight M per unit area of the bonding agent 4 30 g/m².

<The Test 1 (the Peel Strength H and So On)>

In the test 1, we measure the peel strengths H in a vertical direction (a warp direction) and a horizontal direction (a welt direction) of the cover members 1 before and after performing a washing treatment shown in 103 method of JIS-L-0217:1995 for 1 time (before and after washing), against the above-mentioned working examples 1 to 3, we show the results on Table 1.

Furthermore, in the test 1, the peel strengths H are measured by a predetermined standard.

TABLE 1

Peel Strength H
(N/cm)

| | | Vertical | Horizontal |
|---|---|---|---|
| | | Direction | Direction |
| Working | Before | 2.5 | 1.9 |
| Example 1 | Washing | | |
| | After | 3.0 | 2.4 |
| | Washing | | |
| Working | Before | 4.8 | 5.1 |
| Example 2 | Washing | | |
| | After | 3.8 | 6.3 |
| | Washing | | |
| Working | Before | 4.8 | 12.9 |
| Example 3 | Washing | | |
| | After | 3.3 | 9.3 |
| | Washing | | |

<The Estimation of the Test 1 (the Peel Strength H and So On)>

As shown in Table 1, though the skin material 2 and the lining material 3 (the multistory knitting fabric3′) are exactly the same in the working examples 1 to 3, the peel strengths H before and after washing are slightly different, according to each of the material and/or the weight M per unit area of the bonding agent 4 differing each other, we secure that the peel strength H is at least 1.9N/cm, regardless of before washing or after washing, and a vertical direction of a horizontal direction. In the working examples 1 to 3, there is no abnormality such as peeling et cetera also after washing, the working examples 1 to 3 have a competent washing resistance.

Then, because of Table 1, it is revealed that the peel strength H of the working examples 1 to 3 is not less than 1.0 N/cm and not more than 10.0 N/cm in at least one direction of the vertical direction and the horizontal direction of the cover member 1 after performing the washing treatment for 1 time.

Furthermore, it can also be said that a value of the peel strength H itself of working example 3, which the material of the bonding agent 4 is polyester resin, is higher than a value of the peel strengths H of the working examples 1, 2, which the material of the bonding agent 4 is polyamide resin.

And, the peel strengths H in the vertical direction and the horizontal direction of the working example 1 after washing, and/or the peel strengths H in horizontal direction of the working example 2 after washing become higher than the peel strengths H before washing.

<The Test 2 (The Moisture Content Rate BnK″ and So On)>

In the test 2, we measure weights (A) of the cover member 1 before performing a washing treatment shown in 103 method of JIS-L-0217:1995 for 1 time (before washing), we measure weights (B0) immediately after said washing treatment (immediately after washing, thereafter, we measure weights per 1 hour after performing the washing treatment (per 1 hour after washing, if 1 hour passes after washing, we measure weights (B1), if 2 hours pass after washing, we measure weights (B2), if n hours pass after washing, we measure weights (Bn)), against the above-mentioned working examples 1, 2 and comparative example 1, we show the results on Table 2.

And, in the test 2, as based on values of this Table 2, we calculate moisture content amounts BnK′ of in the cover members 1 when n hours pass after washing, according to subtracting Bn from A (=Bn−A), we show the results on Table 3. We calculate moisture content rates BnK″ (units is %) of in the cover members 1 when n hours pass after washing, according to dividing what A subtracted from Bn by A (=(Bn−A)/A), we show the results on Table 4.

At this point, in the test 2, sizes of samples of the working examples 1, 2 and the comparative example 1 are 20 cm*20 cm, a temperature of a drying condition is 21 degree centigrade, a relative humidity of the drying condition is 50.6% RH, a drying method of the drying condition is “hang and dry”.

Furthermore, units of values of in Tables 2, 3 are g (gram).

And, though values of the moisture content amounts B3K′, B4K′ if the working examples 1, 2 and the comparative example 1 in Table 3 are negative, it is thought measurement errors, it makes values of the moisture content rates B3K″, B4K″ of the working examples 1, 2 and the comparative example 1 in Table 4 0%.

TABLE 2

| | A | B0 | B1 | B2 | B3 | B4 |
|---|---|---|---|---|---|---|
| Working | 26.86 | 36.33 | 30.83 | 27.33 | 26.83 | 26.83 |
| Example 1 | | | | | | |
| Working | 27.30 | 34.24 | 29.88 | 27.30 | 27.26 | 27.25 |
| Example 2 | | | | | | |
| Comparative | 12.85 | 20.86 | 16.38 | 13.37 | 12.84 | 12.84 |
| Example 1 | | | | | | |

※units of values of in table is (g).

TABLE 3

| | B0K′ | B1K′ | B2K′ | B3K′ | B4K′ |
|---|---|---|---|---|---|
| Working | 9.47 | 3.97 | 0.47 | −0.03 | −0.03 |
| Example 1 | | | | | |
| Working | 6.94 | 2.58 | 0.00 | −0.04 | −0.04 |
| Example 2 | | | | | |
| Comparative | 8.01 | 3.53 | 0.52 | −0.01 | −0.01 |
| Example 1 | | | | | |

※units of values of in table is (g).

TABLE 4

| | B0K″ | B1K″ | B2K″ | B3K″ | B4K″ |
|---|---|---|---|---|---|
| Working | 35% | 15% | 2% | 0% | 0% |
| Example 1 | | | | | |
| Working | 25% | 9% | 0% | 0% | 0% |
| Example 2 | | | | | |
| Comparative | 62% | 27% | 4% | 0% | 0% |
| Example 1 | | | | | |

※units of values of in table is (g).

<The Estimation of the Test 2 (the Moisture Content Rate BnK″ and So On)>

As shown in Tables 2 to 4, though the skin material 2 is the same in the working examples 1, 2 and the comparative example 1, the moisture content rates B0K″ immediately after washing already are greatly different, according to differing whether the lining material 3 is the multistory knitting fabric 3′ or the lining material 3 is the urethane foaming material. Also when 1 hour passes after performing a washing treatment, the moisture content rates B1K″ continue to greatly differ each other, this is, also when 2 hours pass after performing a washing treatment, there are differences between the moisture content rates B1K″.

Consequently, it can realize “the shortening of the drying time”, according to making the lining material 3 the multistory knitting fabric3′.

Then, because of Table 4, it is revealed that the moisture content rates B2K″ of cover members 1 of the working examples 1, 2 are not more than 3%, when 2 hours pass after performing the washing treatment for 1 time.

<The Test 3 (the Ventilation Degree T)>

In the test 3, we measure ventilation degrees T of the above-mentioned working examples 1, 2 and comparative example 1, we show the results on Table 5.

Furthermore, in the test 3, the ventilation degrees T are measured by a predetermined standard.

TABLE 5

| | Ventilation Degree T |
|---|---|
| | (ml/cm²/sec) |
| Working | 28.9 |
| Example 1 | |
| Working | 18.2 |
| Example 2 | |
| Comparative | 28.1 |
| Example 1 | |

<The Estimation of the Test 3 (the Ventilation Degree T)>

As shown in Table 5, though values themselves of the ventilation degrees T are not greatly different between the working examples 1, 2 and the comparative example 1, as mentioned above in the test 2, because the moisture content rates B0K″ immediately after washing and the moisture content rates B1K″ when 1 hour passes after performing a washing treatment et cetera differ greatly in the working examples 1, 2 making the lining material 3 the multistory knitting fabric3′, the working examples 1, 2 can achieve both “the securement of the ventilation property” and “the shortening of the drying time” comparable to a case making the lining material 3 the urethane foaming material, according to making the lining material 3 the multistory knitting fabric3′. And also, as shown in the test 1, there is no abnormality such as peeling et cetera also after washing, it can be said that it also realizes “competent washing resistance” at the same time.

<The Test 4 (the Washing Resistance)>

In the test 4, we show an external appearance of the cover 1 of the above-mentioned working example 5 after performing treatments of dry cleaning as washing treatments for predetermined times in the following Table 6.

At this point, “dry cleaning” does not only include a dry cleaning as it is disclosed in 401method of JIS-L-0217:1995, but also includes treatments conformed to dry cleanings disclosed in said JIS.

TABLE 6

| | Number of Time of Dry Cleaning | | |
|---|---|---|---|
| | (Time) | | |
| | 1 | 5 | 10 |
| External | There is no | There is no | There is no |
| Appearance | abnormality | abnormality | abnormality |
| | such as peeling | such as peeling | such as peeling |
| | et cetera. | et cetera. | et cetera. |

As shown in Table 6, if repeatedly performing dry cleaning for predetermined times, there is no abnormality such as peeling et cetera on the external appearance of the working example 5, the working example 5 has competent washing resistance.

Thus, the cover member 1 of the present invention is capable of washing (washable), and also it realizes “the securement of the ventilation property”, “the shortening of the drying time” et cetera at the same time.

<The Others>

The present invention is not limited the above-mentioned embodiments. Each constitution, whole construction, shape and/or dimension of the cover member 1 et cetera can change appropriately in accordance with a purport of the present invention.

A functional resin such as water-repellent antifouling may be coated on the cover member 1.

The cover member 1 may be applied printing by ink jet et cetera, seals et cetera may be stuck on the cover member 1.

In a case that the cover member 1 comprises another material such as a sheet-like material and/or a mesh-like material (a net-like material) between the skin material 2 and the lining material 3, in addition to the skin material 2 and the lining material 3, the bonding agent 4 may be adhered at least a part of between the another material and the skin material 2, and/or the bonding agent 4 may be adhered at least a part of between the another material and the lining material 3. Similarly, in a case that there is a plurality of another materials between the skin material 2 and the lining material 3, the bonding agent 4 may be adhered at least a part of any between the skin material 2, the lining material 3 and each another material.

In a case that the skin material 2 is a cloth, the bonded part 5 may be arranged in a place which threads constituting the skin material 2 and threads constituting the lining material (the multistory cloth) 3 are contacting.

### INDUSTRIAL APPLICABILITY

The cover member of the present invention can be used for not only a car seat of a passenger car, but also a seat of conveyance such as other vehicle, an aircraft and a watercraft, moreover, the cover member of the present invention is available to a chair of home use and/or business use.

### EXPLANATION OF NUMERALS AND SYMBOLS

1 cover member
2 skin material
2b back of skin material
3 lining material (multistory cloth)
3′ multistory knitting fabric
4 bonding agent
5 bonded part
5′ non-bonded part
S seat
F adhesion ratio
H peel strength
B2K″ moisture content rate when 2 hours pass after performing a washing treatment

1. A seat detachable cover member characterized by the following;
the cover member comprises at least a skin material and a lining material which is positioned on a back side of the skin material;
the lining material is a multistory cloth which is bonded on the back side of the skin material through a bonding agent;
the cover member comprises a bonded part which the bonding agent is adhering and a non-bonded part which the bonding agent is not adhering between the multistory cloth and the skin material.

2. The cover member as claimed in claim 1, characterized by the following;
the multistory cloth is a multistory knitting fabric which is knitted by polyester resin-made threads.

3. The cover member as claimed in claim 1, characterized by the following;
the bonded part is arraged in any one out of a net-like shape, a dot-like shape and a checkered pattern.

4. The cover member as claimed in claim 1, characterized by the following;
the bonded part is arranged irregularly.

5. The cover member as claimed in claim 1, characterized by the following;
a zone occupied by the bonded part is narrower than a zone occupied by the non-bonded part;
the cover member comprises a plurality of the bonded parts, and the bonded parts are not continuous mutually;
the cover member comprises one the non-bonded part, and the non-bonded part is continuous;
the bonded parts are arranged to be surrounded by the non-bonded part.

6. The cover member as claimed in claim 1, characterized by the following;
the multistory cloth is a double raschel knitting fabric which is connected between two sheets of warp knitting fabrics knitted by polyester resin-made warp threads with connection threads;
the skin material is a warp knitting fabric knitted by polyester resin-made warp threads.

7. The cover member as claimed in claim 1, characterized by the following;
an adhesion ratio, which is a rate of the bonded part occupying per unit area, is not less than 10% and not more than 90%.

8. A seat detachable cover member characterized by the following;
the cover member comprises at least a skin material and a lining material which is positioned on a back side of the skin material;
the lining material is a multistory cloth which is bonded on the back side of the skin material through a bonding agent;
a peel strength between the skin material and the lining material, which are bonded by the bonding agent, is not less than 1.0 N/cm and not more than 10.0 N/cm in at least one direction of a vertical direction and a horizontal direction of said cover member, after performing a washing treatment represented by 103 method of JIS-L-0217:1995 or 140 method of JIS-L-0001:2014 against said cover member for 1 time.

9. A seat detachable cover member characterized by the following;
the cover member comprises at least a skin material; and a lining material which is positioned on a back side of the skin material;
the lining material is a multistory cloth which is bonded on the back side of the skin material through a bonding agent;
a moisture content rate of said cover member is not more than 3%, when 2 hours pass after performing a washing treatment represented by 103 method of JIS-L-0217:1995 or 140 method of JIS-L-0001:2014 against said cover member for 1 time.
